(19) United States
(12) Patent Application Publication
(10) Pub. No.: US 2020/0334264 A1
(43) Pub. Date: Oct. 22, 2020

(54) MIGRATION OF USER RELATED STATE ACROSS DEVICES

(71) Applicant: Intel Corporation, Santa Clara, CA (US)

(72) Inventors: William J. Lewis, Portland, OR (US); Barnes Cooper, Hillsboro, OR (US); Aleksander Magi, Portland, OR (US); Marko Bartscherer, Fairview, OR (US)

(73) Assignee: Intel Corporation, Santa Clara, CA (US)

(21) Appl. No.: 16/914,175

(22) Filed: Jun. 26, 2020

(51) Int. Cl. G06F 16/2457; G06K 9/62; H04L 29/08

(52) U.S. Cl. CPC G06F 16/24578; H04L 67/1095; G06K 9/6215

(57) ABSTRACT

Particular embodiments described herein provide for an electronic device that can be configured to include one or more processors, a user proximity sensor, a user proximity engine, and a state synchronization engine. The user proximity engine is configured to cause the one or more processors to determine if the electronic device is the most relevant device to the user. The state synchronization engine configured to cause the one or more processors to determine the state of the electronic device and communicate the state of the electronic device to a second electronic device if the electronic device is determined to be the most relevant device to the user.

### TECHNICAL FIELD

This disclosure relates in general to the field of computing, and more particularly, to the migration of user related state across devices.

### BACKGROUND

End users have more electronic device choices than ever before. A number of prominent technological trends are currently afoot and some of the technological trends can place increasing performance demands on the system by the user. In addition, more and more users are using multiple devices such as smart televisions, Internet of Things (IoT) devices, gaming systems, etc.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a system to enable migration of user related state across devices, in accordance with an embodiment of the present disclosure;

FIG. 1B is a simplified block diagram of a system to enable migration of user related state across devices, in accordance with an embodiment of the present disclosure;

FIG. 1C is a simplified block diagram of a system to enable migration of user related state across devices, in accordance with an embodiment of the present disclosure;

FIG. 2 is a simplified partial block diagram view of a portion of an electronic device to enable migration of user related state across devices, in accordance with an embodiment of the present disclosure;

FIG. 3 is a simplified partial block diagram of a system to enable migration of user related state across devices, in accordance with an embodiment of the present disclosure;

FIG. 4 is a simplified flowchart illustrating potential operations that may be associated with the system in accordance with an embodiment of the present disclosure;

FIG. 5 is a simplified flowchart illustrating potential operations that may be associated with the system in accordance with an embodiment of the present disclosure;

FIG. 6 is a simplified flowchart illustrating potential operations that may be associated with the system in accordance with an embodiment of the present disclosure;

FIG. 7 is a simplified flowchart illustrating potential operations that may be associated with the system in accordance with an embodiment of the present disclosure; and

FIG. 8 is a simplified flowchart illustrating potential operations that may be associated with the system in accordance with an embodiment of the present disclosure.

The FIGURES of the drawings are not necessarily drawn to scale, as their dimensions can be varied considerably without departing from the scope of the present disclosure.

### DETAILED DESCRIPTION

### Example Embodiments

The following detailed description sets forth examples of apparatuses, methods, and systems relating to enable migration of user related state across devices. The term “state,” and its derivatives includes user configurable settings and open applications. The term “open applications” includes applications that are active and applications that are idle or in a standby or sleep mode. The open applications include user related content. The term “user related content” includes information and data that is being used by the user (e.g., information and data related to documents, spreadsheets, videos, music, etc.).

Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example.

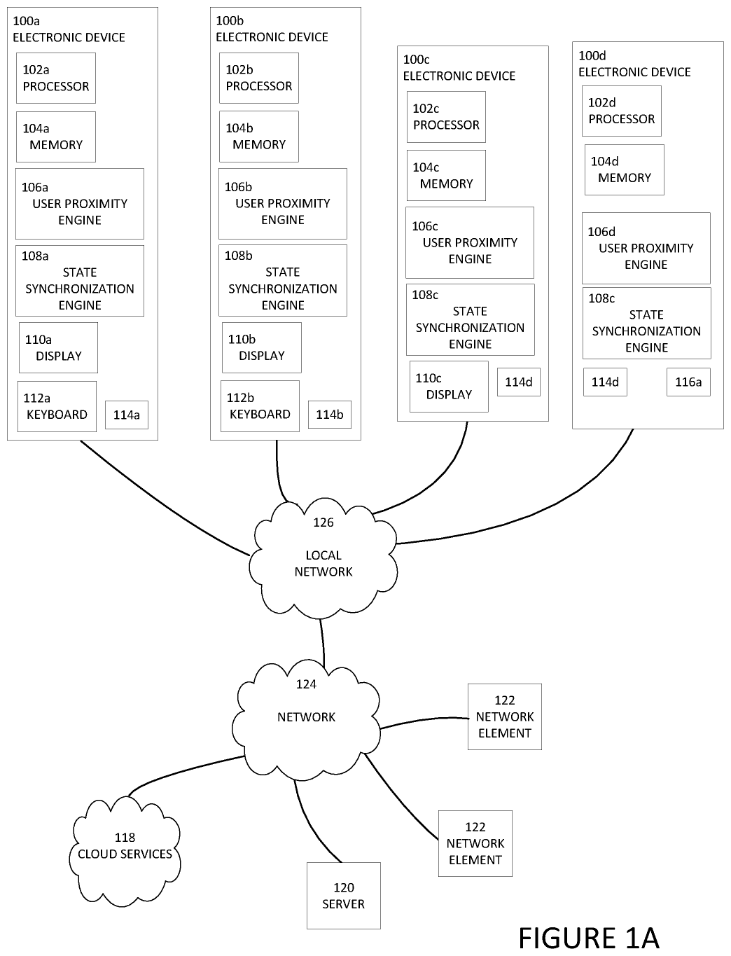

FIG. 1A is a simplified block diagram of electronic devices configured to facilitate enabling migration of user related state across devices, in accordance with an embodiment of the present disclosure. In an example, an electronic device 100a can include a processor 102a, memory 104a, a user proximity engine 106a, state synchronization engine 108a, a display 110a, a keyboard 112a, and a user proximity sensor 114a. An electronic device 100b can include can include a processor 102b, memory 104b, a user proximity engine 106b, a state synchronization engine 108b, a display 110b, a keyboard 112b, and a user proximity sensor 114b. An electronic device 100c can include a processor 102c, memory 104c, a user proximity engine 106c, a state synchronization engine 108c, a display 110c, and a user proximity sensor 114c. An electronic device 100d can include a processor 102d, memory 104d, a user proximity engine 106d, a state synchronization engine 108d, a user proximity sensor 114d, and a user notification engine 116a. User notification engine 116a may be a speaker, vibration device to create a vibration alert, or some other device that can notify the user by some means other than using a display. In some examples, each of electronic devices 100a-100d may also include a user notification engine similar to user notification engine 116a. Each of electronic devices 100a-100d may be in communication with cloud services 118, server 120, and/or one or more network elements 122 using network 124. In addition, each of electronic devices 100a-100d can be in communication with each other using local network 126. Local network 126 can be in communication with network 124. Local network 126 may be created by a router. In some examples, one or more of electronic devices 100a-100d may be a standalone device and not connected to network 124 but can still communicate with another device either through local network 126 or some other short range communication means (e.g., Bluetooth, Wi-Fi, near-field communication (NFC), ultra-wideband (UWB), ultrasound beaconing, etc.)

Turning to FIG. 1B, FIG. 1B is a simplified block diagram of a system configured to facilitate enabling migration of user related state across devices, in accordance with an embodiment of the present disclosure. In an example, an electronic device 100e can include a processor 102e, memory 104e, a user proximity engine 106e, a display 110e, a keyboard 112e, and a user proximity sensor 114e. An electronic device 1001 can include can include a processor 102f, memory 104f, a user proximity engine 106f, a display 110f, a keyboard 112f, and a user proximity sensor 114f. An electronic device 100g can include a processor 102g, memory 104g, a user proximity engine 106g, a display 110g, and a user proximity sensor 114g. An electronic device 100h can include a processor 102h, memory 104h, a user proximity engine 106h, a user proximity sensor 114h, and a user notification engine 116b. User notification engine 116b may be a speaker, vibration device to create a vibration alert, or some other device that can notify the user by some means other than using a display. In some examples, each of electronic devices 100e-100g may also include a user notification engine similar to user notification engine 116b. Each of electronic devices 100e-100h may be in communication with cloud services 118, server 120, and/or one or more network elements 122 using network 124. In addition, each of electronic devices 100a-100d can be in communication with each other using local network 126. Local network 126 can be in communication with network 124. In an example, local network 126 can include a state synchronization engine 108e. In another example, electronic device 100e, electronic device 100f, electronic device 100g, and/or electronic device 100h may include a state synchronization engine 108e in addition to or instead of local network 126 including state synchronization engine 108e.

Turning to FIG. 1C, FIG. 1C is a simplified block diagram of a system configured to facilitate enabling migration of user related state across devices, in accordance with an embodiment of the present disclosure. In an example, electronic device 100e can include processor 102e, memory 104e, user proximity engine 106e, display 110e, keyboard 112e, and user proximity sensor 114e. Electronic device 100f can include can include processor 102f, memory 104f, user proximity engine 106f, display 110f, keyboard 112f, and user proximity sensor 114f. Electronic device 100g can include processor 102g, memory 104g, user proximity engine 106g, display 110g, and user proximity sensor 114g. Electronic device 100h can include processor 102h, memory 104h, user proximity engine 106h, user proximity sensor 114h, and user notification engine 116b. Each of electronic devices 100e-100h may be in communication with cloud services 118, server 120, and/or one or more network elements 122 using network 124. In an example, cloud services 118 can include a state synchronization engine 108f, server 120 can include a state synchronization engine 108g, and/or one or more network elements 122 can include a state synchronization engine 108h.

Each user proximity sensor 114a-114h can be used to detect when a user is at or near an electronic device associated with the proximity sensor. For example, user proximity sensor 114a can detect when the user is at or near electronic device 100a, user proximity sensor 114b can detect when the user is at or near electronic device 100b, user proximity sensor 114c can detect when the user is at or near electronic device 100c, user proximity sensor 114d can detect when the user is at or near electronic device 100d, user proximity sensor 114e can detect when the user is at or near electronic device 100e, user proximity sensor 114f can detect when the user is at or near electronic device 100f, user proximity sensor 114g can detect when the user is at or near electronic device 100g, and user proximity sensor 114h can detect when the user is at or near electronic device 100h. Each user proximity sensor 114a-114h can be a webcam, camera, IR sensor, near term sensor to detect when the user is near an electronic device, a sensor that detects when a user is entering in a passcode, a sensor that detects when a user is waking up an electronic device, a sensor that detects when a user is moving a mouse or interacting with some other peripheral associated with the electronic device, or some other means to detect a user's presence around an electronic device.

Each user proximity engine 106a-106h can be configured to use data from one or more proximity sensors (e.g., user proximity sensor 114a-114h) and determine an electronic device a user is currently focused on and/or what devices are in close proximity to the user. The term “close proximity to the user” includes when an electronic device is within arm's reach of the user and/or when the user is less than about four (4) feet from the electronic device. For example, if user proximity sensor 114a is a camera and user proximity sensor 114a detects that a user is looking at display 110a, then user proximity engine 106a can determine that the user is currently focused on electronic device 100a. In another example, if user proximity sensor 114c is a sensor that detects when a user is entering in a passcode using a virtual keyboard on display 110c, then user proximity engine 106c can determine that the user is currently focused on electronic device 100c. Each user proximity engine 106a-106h can be configured to communicate with other user proximity engines to determine an electronic device that is most relevant to the user. The term “the device most relevant to the user” includes the device that user is currently focused on and/or what device is nearest to the user. For example, if user proximity sensor 114a is a camera and user proximity sensor 114a detects that a user is facing display 110a of electronic device 100a but user proximity sensor 114c detects the user is entering in a passcode using a virtual keyboard on display 110c of electronic device 100c, then user proximity engine 106a and 106c can communicate with each other and determine that even though the user is facing display 110a of electronic device 100a, the user is currently focused on electronic device 100c because that is where the user entered in the passcode.

Each of state synchronization engines 108a-108h can be configured to automatically transfer user related state of a specific device that is associated with a specific state synchronization engine to another device and allow the system to maintain the user related state across electronic devices 100a-100h. The term “automatically transfer” includes a transfer where the user does not need to directly initiate the transfer or actively cause the transfer to happen. State synchronization engine 108a-108h can be configured to determine the state of a device that was being used by the user and transfer the state to the device currently being used by the user. More specifically, state synchronization engine 108a can determine the state of electronic device 100a and transfer the state of electronic device 100a to electronic devices 100b-100d, state synchronization engine 108b can determine the state of electronic device 100b and transfer the state of electronic device 100b to electronic devices 100a, 100c, and 100d, state synchronization engine 108c can determine the state of electronic device 100c and transfer the state of electronic device 100c to electronic devices 100a, 100b, and 100d, and state synchronization engine 108d can determine the state of electronic device 100d and transfer the state of electronic device 100d to electronic devices 100a-100c. The user related state of a device includes what applications are open on the device, what user inputs and outputs are open on the device, where the cursor is located, the volume settings, display brightness level, input or output tangible to the user, what and where the user was editing, etc. This allows the user's digital content to follow the user from device to device and across device transitions.

In an illustrative example of a video being viewed on a first device, the state that is related to the video that would be transferred to a second device includes the URL or file the user was playing, the application that was being used to view the video, the portion of the video file the user was viewing or location of the playback, whether close caption is on, the time code for a video that is playing, the playback speed, size of the window or display where the video was being displayed to the user, etc. If the user was clicking on a file menu on a first device and then the user goes to another room to use a new second device, the state synchronization engine associated with the first device knows the user was clicking on a file menu so it communicates with the state synchronization engine associated with the second device to restore that state to the second device and the file menu and cursor location of the first device would be on the second device. If the complete state of the first device cannot be transferred to the second device, then the portions of the state that can be transferred are transferred. If the second device cannot handle the entire state, if it is not being transferred from the first device, then the system can prompt the user on how the user wants to fill in the portions of the user related state that are not transferred to the second device. If the second device cannot replicate the state from the first device, then the second device will fill in the blanks with what is available on the second device. For example, if a user was using a videoconferencing feature (e.g., FaceTime®) on a phone for a video call, the system could transfer the video call to a videoconferencing feature (e.g., Skype®) on a desktop computer. In another example, if Visio is open on a desktop computer and the state of the desktop is transferred to a phone, a prompt on the phone may be sent to the user to download Visio on the phone or some other application that can open the Visio file or the system may make a PDF of the Visio file so it can be displayed on the phone. In another example, a user may be walking or moving around with their laptop and travel near a television. The television can include a camera or proximity sensor that can determine the user is near the television and is carrying a laptop or some other device. The television can prompt the user and/or laptop that the television can transfer some state from the laptop. For example, a video that is being watched by the user on the laptop can be transferred to the television but a prompt will not be sent to the user and/or laptop that a document can be transferred from the laptop to the television because the television does not have the ability for the user to edit the document. In yet another example, the laptop may have a proximity sensor that can scan an environment around the user (e.g., a room) and determine devices in the environment that can a portion of the state of the laptop. The laptop or device that can accept the portion of state of the laptop can prompt the user to transfer just a portion of state of the laptop to the device.

Each state synchronization engine 108 can transfer a full-context of the user related state from device to device, not simply application data or mirror what is shown on a screen of a first device to another screen on a second device. This is different from a handoff that enables transfer of application related information but does not include information about systems or data related to user context. More specifically, during a handoff, the user must start the application on both a first device and on a second device and proactively push data from the first device to the second device. When there is a handoff, applications work together across devices and it can be application data that is transferred but the system context and system state across devices is not transferred.

Some applications use a cloud to store application related data and when the user transfers to a new device, the new device uses the data in the cloud to update the application on the new device. In an example, each state synchronization engine 108 can be configured to automatically transition state from one device to another device as the user moves through an environment without the use of the cloud. Some web browsers synchronize tabs across devices but the current web browsers do not synchronize state across devices. Each state synchronization engine 108 can be configured to synchronize open tabs, the location of where the user was on a web page, cookies, a cursor location on the web page, etc. Each state synchronization engine 108 can automatically transfers application state as well as user context and/or system state between the users most relevant devices. The most relevant device is the device that the user is currently looking at, the device the user is currently using, and/or is the device that is closest to a user that can deliver an incoming communication (e.g., alert, phone call, text, or etc.) to the user. To help determine the most relevant device, the user's presence may be detected by a user proximity engine (e.g., user proximity sensor 114a), a webcam, camera, IR sensor, near term sensor to detect when the user is around the device, entering in a passcode, waking up the device, moving a mouse, or some other means to detect a user's presence around a device.

In some examples, alerts may be presented to the user on the most relevant device rather than having the alert appear on a plurality of devices. For example, in current systems, an alert related to a call, text, calendar notification, etc. may appear on multiple devices at about the same time. Each state synchronization engine 108 can be configured to deliver the alert to the most relevant device to the user. The alert may be delivered using a notification on a display (e.g., display 110a and/or using a notification engine (e.g., user notification engine 116a). Once the alert has been received, the alert is not delivered to other devices to reduce annoyances for the user. If the user is looking at their phone, the notification is sent to the phone, not on the other devices. In another example, if the user is viewing a document or video on their laptop and their phone is close to them but face down, when a text message is communicated to the user, instead of the text going to the phone and laptop, because the user is viewing a document or video on their laptop, the laptop would be the most relevant device and the text message would be delivered to the laptop and not the phone. If the user is viewing a document or video on their laptop but their laptop cannot receive text messages and their phone is close to them but face down, when a text message is communicated to the user, the phone would be the most relevant device because it is the only device near the user that can deliver the incoming communication and the text message would be delivered to the phone.

Elements of FIGS. 1A-1C may be coupled to one another through one or more interfaces employing any suitable connections (wired or wireless), which provide viable pathways for network (e.g., network 124, local network 126, etc.) communications. Additionally, any one or more of these elements of FIGS. 1A-1C may be combined or removed from the architecture based on particular configuration needs. Electronic devices 100a-100h may include a configuration capable of transmission control protocol/Internet protocol (TCP/IP) communications for the transmission or reception of packets in a network. Electronic devices 100a-100h may also operate in conjunction with a user datagram protocol/IP (UDP/IP) or any other suitable protocol where appropriate and based on particular needs.

Network 124 and local network 126 represent a series of points or nodes of interconnected communication paths for receiving and transmitting packets of information that propagate through the system. Network 124 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication. Local network 126 offers a communicative interface between electronic devices 100a-100h and may be configured as any LAN, VLAN, WLAN, and any other appropriate architecture or system that facilitates communications in a network environment, or any suitable combination thereof, including wired and/or wireless communication.

In the system, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Messages through the network could be made in accordance with various network protocols, (e.g., Ethernet, Infiniband, OmniPath, etc.). Additionally, radio signal communications over a cellular network may also be provided in the system. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. The data may help determine a status of a network element or network. Additionally, messages, requests, responses, and queries are forms of network traffic, and therefore, may comprise packets, frames, signals, data, etc.

It is to be understood that other embodiments may be utilized and structural changes may be made without departing from the scope of the present disclosure. Substantial flexibility is provided by electronic devices 100a-100h in that any suitable arrangements and configuration may be provided without departing from the teachings of the present disclosure.

For purposes of illustrating certain example techniques of electronic devices 100a-100h, the following foundational information may be viewed as a basis from which the present disclosure may be properly explained. End users have more media and communications choices than ever before. A number of prominent technological trends are currently afoot and some of the technological trends can place increasing performance demands on the system and create a poor user experience. Typically, a user will have more than one device they interact with on a daily basis. For example, most users have at least a desktop or laptop computer and a smartphone. Also, more and more users are using multiple devices such as smart televisions, Internet of Things (IoT) devices, gaming systems, etc. Often, a user will be using one device and need or want to switch to another device. For example, a user may be using their smartphone and reading email. If an email has an attachment that cannot be easily read on the smartphone, the user may decide to open the attachment on their laptop or desktop and must reopen the email and attachment on their laptop or desktop. In another example, a user may be watching a video or accessing a website with their desktop but the user may want to watch the video or access the webpage on a device in a different room and must reload the video or webpage on the device in the different room, set the volume to the desired level, find the location in the video where the user stopped or the page or place on website where they stopped, etc. Some current applications will save the location in the video where the user stopped or the webpage that the user was accessing but these are application-centric statuses and do not take a device's state into consideration (e.g., volume, display, settings, etc.). In other words, with current systems, the current state on one device will not be automatically translated to other devices. What is needed is a system, method, apparatus, etc. to create a means to help enable migration of user related state across devices across devices.

A system for migration of user related state across devices, as outlined in FIGS. 1A-1C, can be used to help resolve these issues (and others). For example, a system can be configured to help enable user devices to transfer state so that the user's context automatically follows them as they transition between devices. More specifically, a state synchronization engine can be configured to help maintain the user's active device and/or most relevant device for interactions, notifications, and incoming content. The state synchronization engine can be configured to determine the capabilities of each device in the system and help allow applications to present content and features appropriate to a specific device. In some examples, applications that cannot be run on a certain system will not migrate to an incapable device. In a specific illustrative example, if a device is a wall display device and an email is received, then the wall display device may only give a notification of the email being received and the email may not be displayed on the wall display device unless the wall display device is configured to receive and edit email and has a keyboard or touchscreen.

In a specific illustrative example, the state synchronization engine can be configured to help enable usages such as opening email on a phone and have the email already open and available when the user moves to another device such as a laptop. The state synchronization engine also enables incoming content and notifications to be delivered and displayed on the most relevant display to the user. This state awareness can be managed by a subsystem within each electronic device. The subsystem can be configured such that the electronic device does not need to be fully awake to synchronize the user related state. For example, even if the electronic device is in a low power configuration, it can still be synchronized. The compute sub-system runs at a lower power than the main operating system and the smaller sub-system can stay in communication and connection to cloud notifications, pushes, network based applications that bring in information into the system, etc.

In current systems, typically notifications are sent to all of the user's devices that are related to the notification. This often causes a large number of stale notifications on devices that the user is not actively using and can be an annoyance to the user. The state synchronization engine can be configured to route notifications to the most relevant display and/or device for the user and maintain a consistent state across all devices so that the notification is delivered directly to the user and the user only receives the notification on one device. In an illustrative example, incoming content, such as telephone calls or content related to telephony services, are typically sent to all of the user devices able to receive the telephone call or content related to telephony services and all the devices give a user alert simultaneously. When the telephone call or content related to telephony services is received, state synchronization engine can be configured to intercept the telephone call or content related to the telephony service and determine the electronic device that is active or most relevant for the user to accept the telephone call or content related to the telephony service. The user can then accept the telephone call or content related to telephony service on their most relevant device or choose to transfer the telephone call or content related to telephony service to another device.

In addition, when the user opens an email on their phone and then opens their laptop, the email is readily available to the user on the laptop. Current systems require the user to manually search for the email on the laptop device. The state synchronization engine can be configured to allow the application context to be transitioned so that the email is opened to the location where the user was last reading.

Typically, users have a number of open applications and documents on a device such as a laptop or desktop computer. The state synchronization engine can be configured to maintain the open and active applications and documents and allow the user to seamlessly use these applications and documents as they transition between devices. This includes having open applications and documents available on any device that the user may use (e.g., phone, tablet, multiple PCs, etc.) and having the state synchronized across devices. For example, all of a user's open word documents and the application state for reading and editing the documents is maintained across devices by the state synchronization engine. The system allows the state of the device to be automatically transferred or follow the user from device to device. Any open applications and the application state would be automatically transferred to the devices that would be used by the end user. For example, if the user has a word document open and is at a certain page in the word document, then that entire experience would be automatically transferred to the next device. It is similar to cloud based sharing applications but the user related state is also transferred so the user does not need to turn on speakers, microphone, etc. as it would all be transferred over to the other devices and any other connected devices would also be transferred to the new device. If the user's attention is on their phone and the user moves to a laptop, then the user related state on each device would be the same or relatively the same whether they were using their phone or switching to the laptop.

In an illustrative example, a use may be working on laptop in kitchen, close the laptop, go to the user's desktop computer in their office and the state of the user's laptop would be on the desktop in office including the cursor being in the spot where the user placed the cursor while using the laptop. If the user is on a smart phone reading an email and needs to open an attachment but needs to see the attachment on a desktop screen, the user can go to the desktop and the email and attachment are open and displayed on the desktop. If the user is on a phone taking pictures or taking pictures with a camera that is connected to a network, the user can go to their laptop and edit the photos on the laptop. The laptop would recognize that the user entered the room either through some type of beaconing or some type of proactive recognition, even if the lid is closed on the laptop and once the laptop detects the user's proximity to the laptop, the system would automatically carbon copy the state of the phone or camera to the laptop so the laptop it is ready when the lid to the laptop is opened.

In addition, the state synchronization engine can be configured to maintain the user's video playback across devices, for example the titles/URIs and time stamp, so that the user can transition between devices without losing continuity. Also, the state synchronization engine can be configured to allow peripherals and connected devices, such as Bluetooth headsets, to transition as the user moves from one device to a new device. The devices communicate with the state synchronization engine to understand the user's most relevant device so that the relevant peripherals can be connected. User related state such as account credentials, WiFi credentials, audio settings (such as volume/mute), and installed applications are also kept in synchronization by the state synchronization engine so that as the user configures new services, they are automatically configured on all the user's device.

The system can be configured to transfer the state that includes the details of the system that are most relevant to the user including volume settings, microphone settings, camera settings, display settings, etc. Some devices can link and play music on all the devices but they are all at a different volume, they are all independently set and current systems do not know where the user is sitting, standing, or listening to the music. The system can be configured to transfer the state dynamically as the user moves through an area such as a house so the user does not have to keep adjusting the volume, microphone, what is showing on the display, etc. The system can be constantly pushing the state content through the sub-system of the devices or the main system on a chip (SoC).

In an example implementation, electronic devices 100a-100h are meant to encompass a computer, a personal digital assistant (PDA), a laptop or electronic notebook, a cellular telephone, mobile device, personal digital assistants, smartphones, tablets, an IP phone, wearables, IoT device, network elements, or any other similar user device, component, element, or object. In some examples, electronic devices 100a-110h may be different types of devices with different types of operating systems. Electronic devices 100a-100h may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Electronic devices 100a-100h may include virtual elements.

In regards to the internal structure associated with electronic devices 100a-100h, electronic devices 100a-100h can include memory elements for storing information to be used in operations or functions. Electronic devices 100a-100h may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in electronic devices 100a-100h could be provided in any database, register, queue, table, cache, control list, or other storage structure, all of which can be referenced at any suitable timeframe. Any such storage options may also be included within the broad term ‘memory element’ as used herein.

In certain example implementations, functions may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities.

Additionally, electronic devices 100a-100h may include one or more processors that can execute software or an algorithm to perform activities. A processor can execute any type of instructions associated with the data to achieve one or more operations. In one example, the processors could transform an element or an article (e.g., data) from one state or thing to another state or thing. In another example, the activities outlined herein may be implemented with fixed logic or programmable logic (e.g., software/computer instructions executed by a processor) and electronic devices 100a-100h could include some type of a programmable processor, programmable digital logic (e.g., a field programmable gate array (FPGA), an erasable programmable read-only memory (EPROM), an electrically erasable programmable read-only memory (EEPROM)) or an ASIC that includes digital logic, software, code, electronic instructions, or any suitable combination thereof. Any of the potential processing elements and modules described herein should be construed as being encompassed within the broad term ‘processor.’

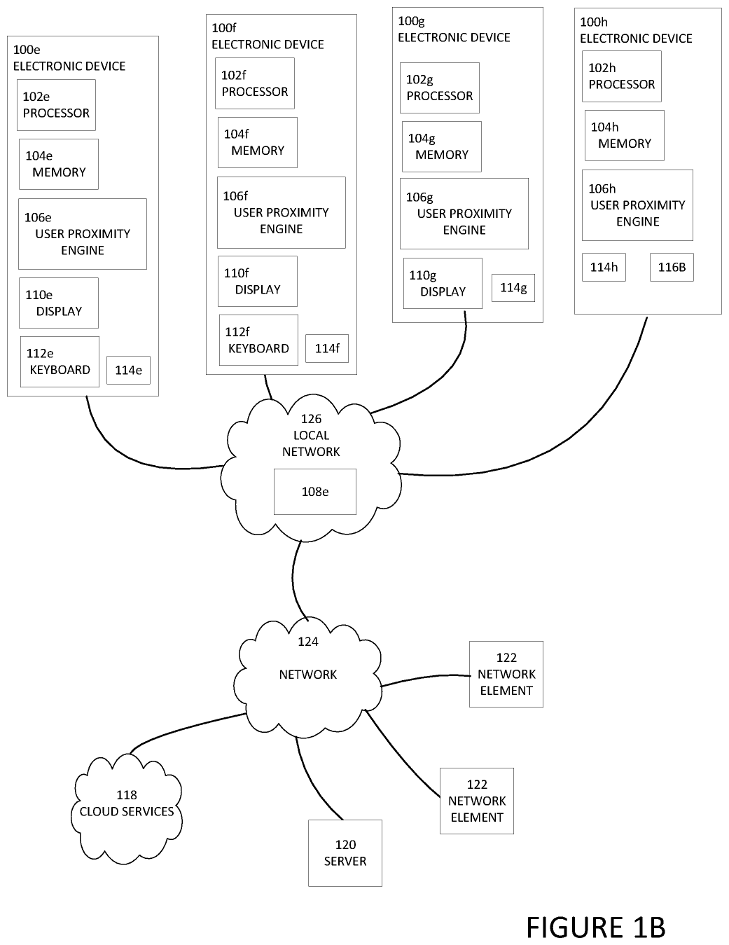

Turning to FIG. 2, FIG. 2 is a simplified block diagram of a portion of an electronic device configured to enable migration of user related state across devices. In an example, a state synchronization engine 108i may be located in one or more of electronic devices 100a-100h and local network 126. More specifically, one or more of state synchronization engines 108a-108e may be the same or similar to state synchronization engine 108i. State synchronization engine 108i can include an alert engine 130, a device state engine 132, and a state matching engine 134. Alert engine 130 can be configured to communicate with one or more user proximity engines (e.g., one or more of user proximity engines 106a-106d illustrated in FIG. 1A or one or more of user proximity engines 106e-106h illustrated in FIG. 1B) to determine the most relevant device and/or a device in close proximity to the user and deliver an incoming communication (e.g., alert, phone call, text, or etc.) to the most relevant device or a device in close proximity to the user if the most relevant device is not able to receive the incoming communication. Device state engine 132 can be configured to determine the state of the electronic device that includes state synchronization engine 108i or a device associated with state synchronization engine 108i. For example, if state synchronization engine 108i is located in local network 126, state synchronization engine 108i may be associated with electronic devices 100e-100h and device state engine 132 can determine the state of each of electronic devices 100e-100h. State matching engine 134 can be configured to receive state information from another device and determine how to match the received state on the electronic device that includes state synchronization engine 108i or a device associated with state synchronization engine 108i. For example, based on received state information from another device, state matching engine 134 can cause a document to be open and a cursor to be located at a specific location within the document, a video or web page to be loaded at a specific location, a volume to be set at a certain level, etc.

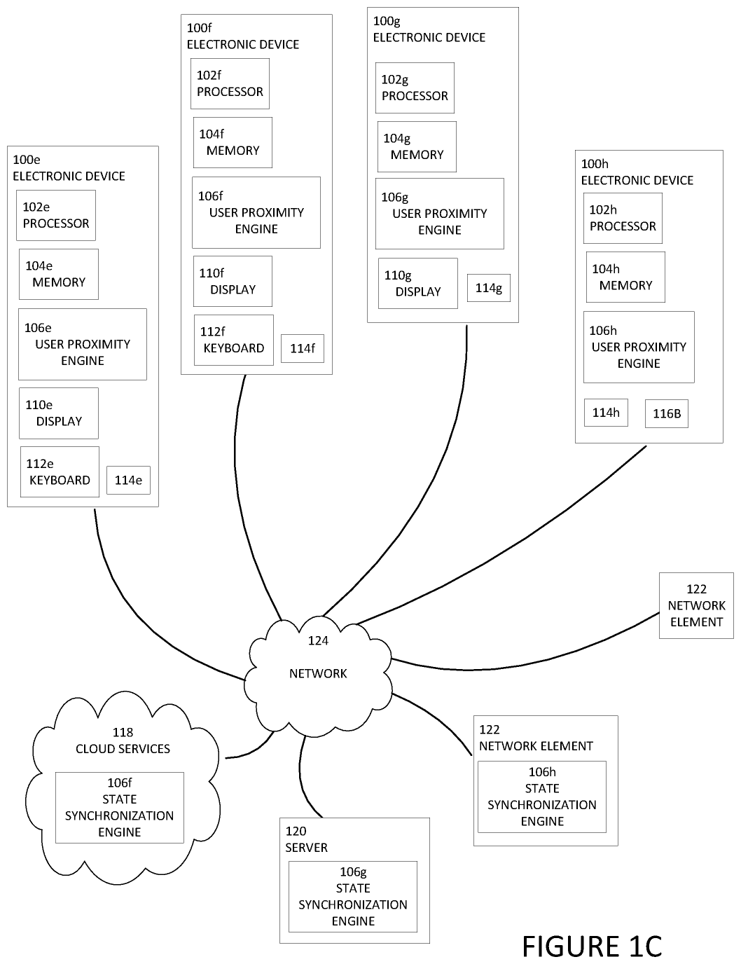

Turning to FIG. 3, FIG. 3 is a simplified block diagram of a portion of system configured to enable migration of user related state across devices. Electronic device 100a can include processor 102a, memory 104a, state synchronization engine 108a, display 110a, and keyboard 112a. Electronic device 100b can include can include processor 102b, memory 104b, state synchronization engine 108b, display 110b, and keyboard 112b. In an illustrative example, electronic device 100a is a laptop computer and electronic device 100b is a desktop computer. In an example, electronic device 100a and electronic device 100b can be different types of devices with different types of operating systems. State synchronization engine 108a, using user proximity engine 106a, can determine that a user is changing from interacting with electronic device 100a to interacting with electronic device 100b.

State synchronization engine 108a can be configured to collect state information about electronic device 100a and communication the collected state information to electronic device 100b. For example, device state engine 132 (illustrated in FIG. 2) in state synchronization engine 108a can be configured to determine the state of electronic device 100a. The collected state information may be communicated to electronic device 100b using local network 126, network 124, through short range communication means (e.g., Bluetooth, Wi-Fi, near-field communication (NFC), ultra-wideband (UWB), ultrasound beaconing, etc.), or using some other means to communicate the collected state information to electronic device 100b. State synchronization engine 108b in electronic device 100b can be configured to receive the state information from electronic device 100a and configure electronic device 100b to match the state of electronic device 100a. For example, state matching engine 134 (illustrated in FIG. 2) in state synchronization engine 108b can be configured to receive the collected state information from state synchronization engine 108a in electronic device 100a and configure electronic device 100b to match the state of electronic device 100a. If electronic device 100b cannot be configured to match the state of electronic device 100a, then state synchronization engine 108b will configure electronic device 100b to match as much of the state of electronic device 100a as possible and either find alternatives to approximately match the state with what is available on electronic device 100b, provide a prompt or notification to the user as to how the state can be matched, or provide the user with a message that the state cannot be matched. For example, if a video was playing on display 110a at a certain volume, brightness, frame rate, etc. and display 110a is a wide screen display but display 110b is not a wide screen display, then the video can be altered or changed to fit on display 110b with the same volume, brightness, frame rate, etc.

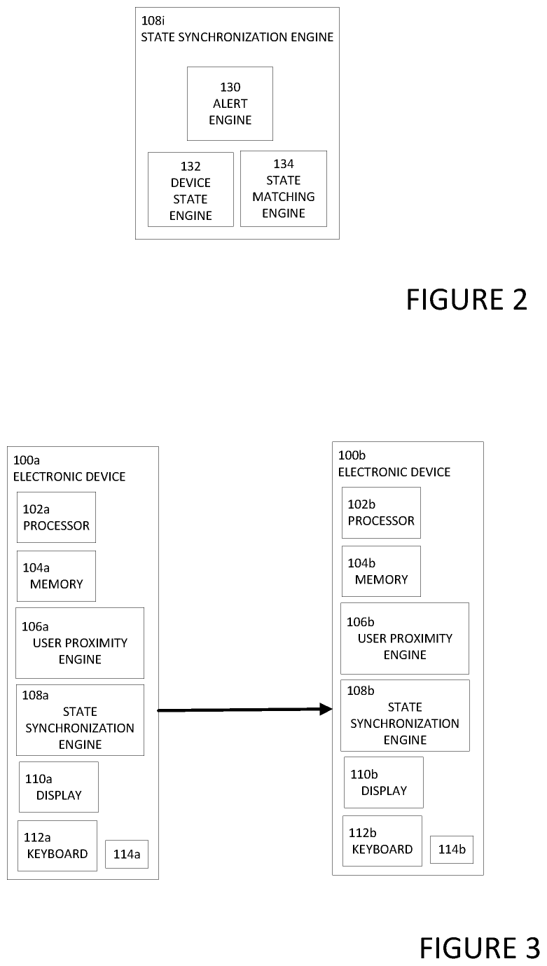

Turning to FIG. 4, FIG. 4 is an example flowchart illustrating possible operations of a flow 400 that may be associated with migration of user related state across devices, in accordance with an embodiment. In an embodiment, one or more operations of flow 400 may be performed by user proximity engine 106, state synchronization engine 108, alert engine 130, device state engine 132 and/or state matching engine 134. At 402, a first device is determined to be a most relevant device to a user. For example, user proximity sensor 114a can detect when the user is at or near electronic device 100a, user proximity sensor 114b can detect when the user is at or near electronic device 100b, user proximity sensor 114c can detect when the user is at or near electronic device 100c, and user proximity sensor 114d can detect when the user is at or near electronic device 100d. A user proximity engine in a first electronic device can communicate with other user proximity engines in other user devices and determine that the first device is most relevant to the user or each user proximity engine can independently determine that the first device is most relevant to the user. More specifically, using user proximity sensor 114a, user proximity engine 106a can determine that the user is near electronic device 100a and using user proximity sensor 114b, user proximity engine 106b can determine that the user is viewing or facing electronic device 100b. User proximity engine 106a can communicate with user proximity engine 106b and determine that even though the user is near electronic device 100a, the user is viewing or facing electronic device 100b so electronic device 100b is the most relevant device to the user. In another specific example, using user proximity sensor 114b, user proximity engine 106b can determine that the user is viewing or facing electronic device 100b and user proximity engine 106b can determine that electronic device 100b is the most relevant device to the user and communicate with the other user proximity engines (e.g., user proximity engines 106a, 106c, and 106d) and inform them that electronic device 100b is the most relevant device to the user.

At 404, the system determines if the first device is the most relevant device to the user. If the system determines that the first device is still the most relevant device to the user, then the system returns to 404 and again determines if the first device is the most relevant device to the user. If the system determines that the first device is not the most relevant device to the user, then a new device is determined to be the most relevant device to the user, as in 406. For example, if user proximity engine 106b determined that the user is viewing or facing electronic device 100b however, using user proximity sensor 114b, user proximity engine 106b determines that the user is no longer near electronic device 100b, then electronic device 100b is no longer the most relevant device to the user and a new device is determined to be the most relevant device to the user. In another example, if electronic device 100b was determined to be the most relevant device to the user, but, using user proximity sensor 114a, user proximity engine 106a determines that the user is now viewing or facing electronic device 100a, then electronic device 100b is no longer the most relevant device to the user.

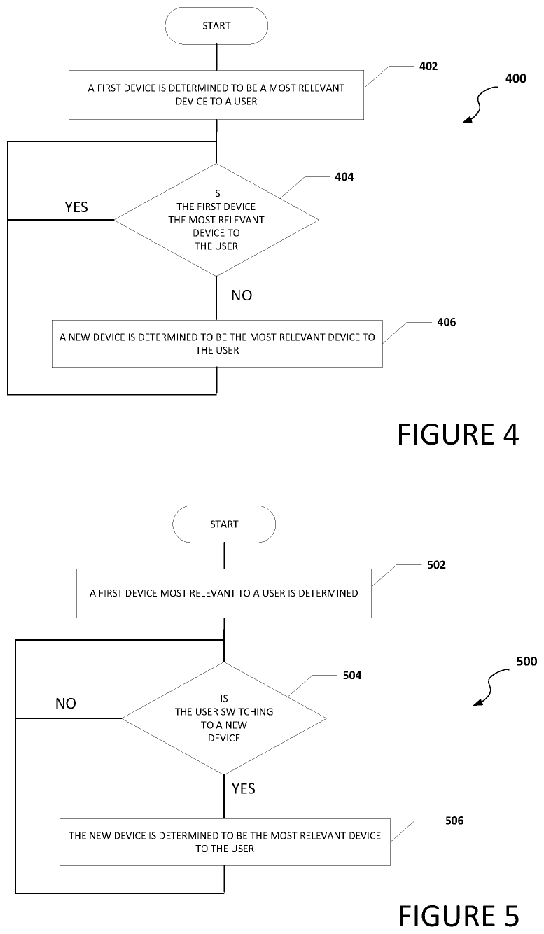

Turning to FIG. 5, FIG. 5 is an example flowchart illustrating possible operations of a flow 500 that may be associated with migration of user related state across devices, in accordance with an embodiment. In an embodiment, one or more operations of flow 500 may be performed by user proximity engine 106, state synchronization engine 108, alert engine 130, device state engine 132 and/or state matching engine 134. At 502, a first device is determined to be a most relevant device to a user. For example, user proximity sensor 114a can detect when the user is at or near electronic device 100a, user proximity sensor 114b can detect when the user is at or near electronic device 100b, user proximity sensor 114c can detect when the user is at or near electronic device 100c, and user proximity sensor 114d can detect when the user is at or near electronic device 100d. Each user proximity engine can communicate with the other user proximity engines and determine a device that is most relevant to the user or each user proximity engine can independently determine the device that is most relevant to the user. More specifically, using user proximity sensor 114a, user proximity engine 106a can determine that the user is near electronic device 100a and using user proximity sensor 114b, user proximity engine 106b can determine that the user is entering a passcode or user authentication related data to electronic device 100b. User proximity engine 106a can communicate with user proximity engine 106b and determine that even though the user is near electronic device 100a, the user is entering a passcode or user authentication related data to electronic device 100b so electronic device 100b is the most relevant device to the user. In another specific example, using user proximity sensor 114b, user proximity engine 106b can determine that the user is entering a passcode or user authentication related data to electronic device 100b and user proximity engine 106b can determine that electronic device 100b is the most relevant device to the user and communicate with the other user proximity engines (e.g., user proximity engines 106a, 106c, and 106d) and inform them that electronic device 100b is the most relevant device to the user.

At 504, the system determines if the user is switching to a new device. If the system determines that the user in not switching to a new device, then the system returns to 504 and again determines if the user is switching to a new device. If the system determines that the user is switching to a new device, then a new device is determined to be the most relevant device to the user, as in 506. For example, if user proximity engine 106b determined that the user is entering a passcode or user authentication related data to electronic device 100b however, using user proximity sensor 114b, user proximity engine 106b determines that the user is no using electronic device 100b, then electronic device 100b is no longer the most relevant device to the user and a new device is determined to be the most relevant device to the user. In other example, if electronic device 100b was determined to be the most relevant device to the user, but, using user proximity sensor 114a, user proximity engine 106a determines that the user is now viewing or facing electronic device 100a, then the user is no longer using electronic device 100b but instead is using electronic device 100a and electronic device 100a is determined to be the most relevant device to the user.

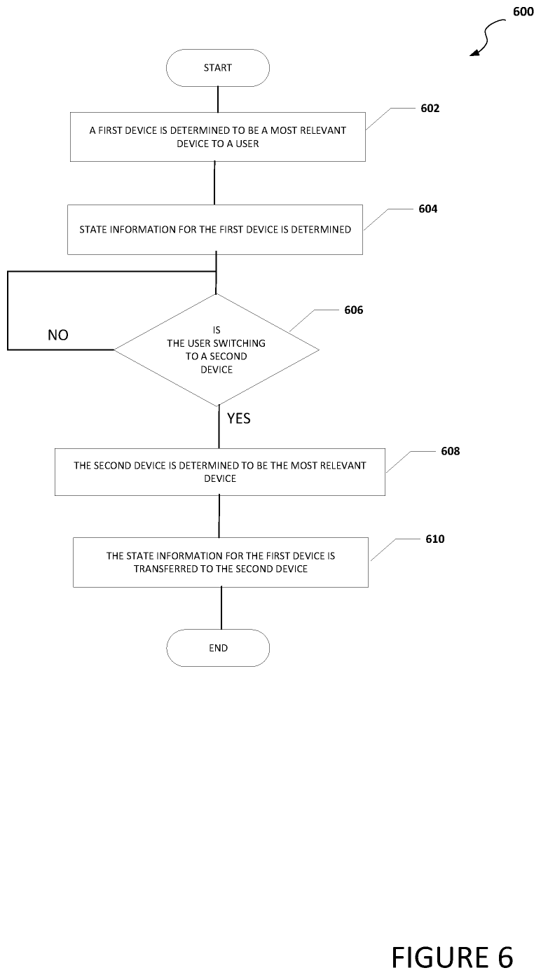

Turning to FIG. 6, FIG. 6 is an example flowchart illustrating possible operations of a flow 600 that may be associated with migration of user related state across devices, in accordance with an embodiment. In an embodiment, one or more operations of flow 600 may be performed by user proximity engine 106, state synchronization engine 108, alert engine 130, device state engine 132 and/or state matching engine 134. At 602, a first device is determined to be a most relevant device to a user. For example, user proximity sensor 114a can detect when the user is at or near electronic device 100a, user proximity sensor 114b can detect when the user is at or near electronic device 100b, user proximity sensor 114c can detect when the user is at or near electronic device 100c, and user proximity sensor 114d can detect when the user is at or near electronic device 100d. Each user proximity engine can communicate with the other user proximity engines and determine that the first device is most relevant to the user or each user proximity engine can independently determine that the first device is most relevant to the user.

At 604, state information for the first device is determined. For example, device state engine 132 in the state synchronization engine associated with the first device can determine the state information for the first device. More specifically, if electronic device 100a is the first device, in an example, device state engine 132 in state synchronization engine 108a can determine the state information for electronic device 100a. In another example, if electronic device 100a is the first device, device state engine 132 in state synchronization engine 108e in local network 126 can determine the state information for electronic device 100a. In yet another example, if electronic device 100a is the first device, device state engine 132 in state synchronization engine 108f in cloud services, state synchronization engine 108g in server 120, or state synchronization engine 108h in network element can determine the state information for electronic device 100a.

At 606, the system determines if the first device is the most relevant device to the user. If the system determines that the first device is still the most relevant device to the user, then the system returns to 606 and again determines if the first device is the most relevant device to the user. If the system determines that the first device is not the most relevant device to the user, then a second device is determined to be the most relevant device to the user, as in 608. For example, if user proximity engine 106a determined that the user is viewing or facing electronic device 100a however, using user proximity sensor 114a, user proximity engine 106a determines that the user is no longer near electronic device 100a, then electronic device 100a is no longer the most relevant device to the user and a second device is determined to be the most relevant device to the user. In other example, if electronic device 100a was determined to be the most relevant device to the user, but, using user proximity sensor 114b, user proximity engine 106b determines that the user is now viewing or facing electronic device 100b, then electronic device 100a is no longer the most relevant device to the user and electronic device 100b is determined to be the most relevant device to the user. At 610, the state information for the first device is transferred to the second device. For example, if electronic device 100a is the first device and electronic device 100b is the second device, device state engine 132 in state synchronization engine 108a can determine the state of electronic device 100a and communicate the state of electronic device 100a to state matching engine 134 in state synchronization engine 108b in electronic device 100b. Using state matching engine 134, state synchronization engine 108b can configure electronic device 100b to match the state of electronic device 100a.

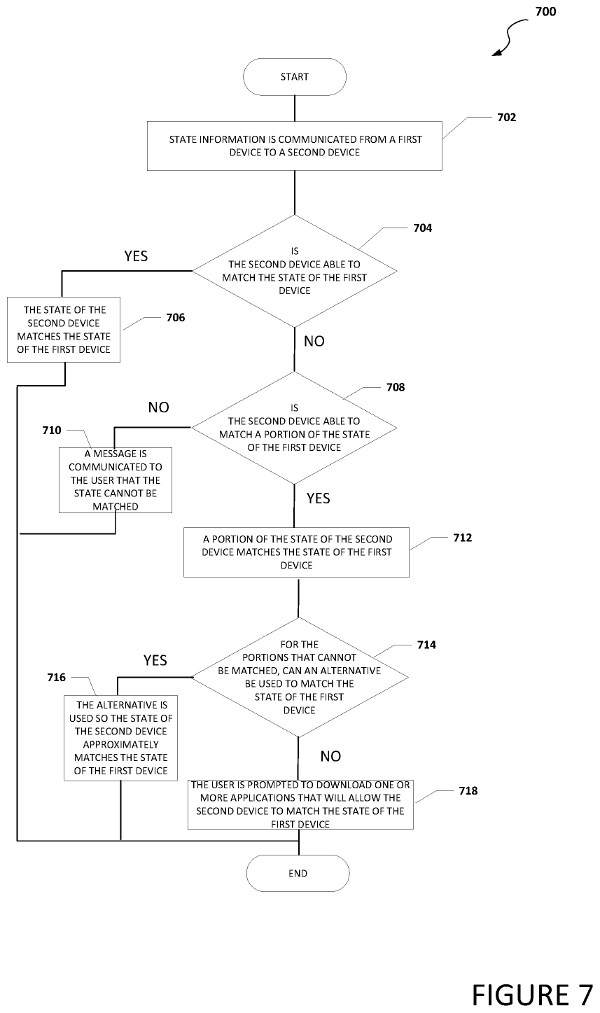

Turning to FIG. 7, FIG. 7 is an example flowchart illustrating possible operations of a flow 700 that may be associated with migration of user related state across devices, in accordance with an embodiment. In an embodiment, one or more operations of flow 700 may be performed by user proximity engine 106, state synchronization engine 108, alert engine 130, device state engine 132 and/or state matching engine 134. At 702, state information is communicated from a first device to a second device. At 704, the system determines if the second device is able to match the state of the first device. If the second device is able to match the state of the first device, then the state of the second device is configured to match the state of the first device, as in 706.

If the second device is not able to match the state of the first device, then the system determines if the second device is able to match a portion of the state of the first device, as in 708. If the second device is not able to match a portion of the state of the first device, then a message is communicated to the user that the state of the first device cannot be transferred to and matched by the second device, as in 710. If the second device is able to match a portion of the state of the first device, then a portion of the state of the second device is configured to match a portion of the state of the first device, as in 712. At 714, for the portions of the state of the first device that the second device was not able to match, the system determines if an alternative can be used to match the state of the first device, as in 714. If the system determines that an alternative can be used to match the state of the first device, then the alternative is used so the state of the second device approximately matches the state of the first device, as in 716. If the system determines an alternative cannot be used to match the state of the first device, then the user is prompted to download one or more applications that will allow the second device to match the state of the first device, as in 718.

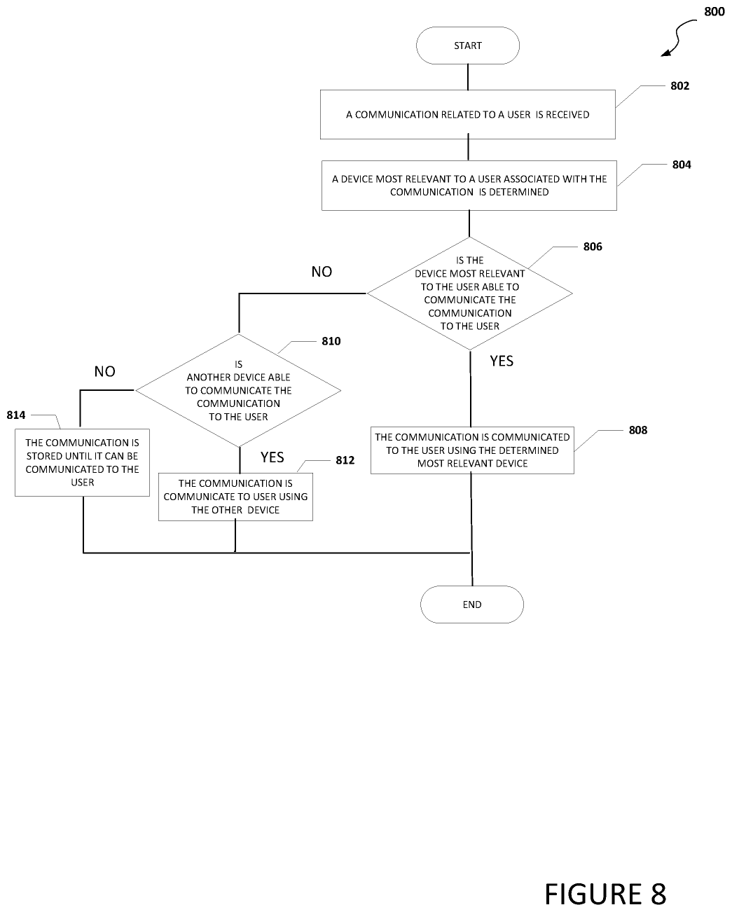

Turning to FIG. 8, FIG. 8 is an example flowchart illustrating possible operations of a flow 800 that may be associated with migration of user related state across devices, in accordance with an embodiment. In an embodiment, one or more operations of flow 800 may be performed by user proximity engine 106, state synchronization engine 108, alert engine 130, device state engine 132 and/or state matching engine 134. At 802, a communication related to a user is received. At 804, a device most relevant to a user associated with the communication is determined. For example, one or more of user proximity engines 106a-106h can be configured to use data from one or more proximity sensors (e.g., user proximity sensors 114a-114h) and determine an electronic device a user is currently focused on and/or what devices are in close proximity to the user. In addition, alert engine 130 can be configured to communicate with user proximity engine 106 to determine the most relevant device and/or one or more devices in close proximity to the user that can receive the incoming communication (e.g., alert, phone call, text, or etc.).

At 806, the system determines if the device most relevant to the user is able to communicate the communication to the user. If the device most relevant to the user is able to communicate the communication to the user, then the communication is communicated to the user using the most relevant device, as in 808. If the device most relevant to the user is not able to communicate the communication to the user, then the system determines if there is another device that is able to communicate the communication to the user, as in 810. If there is another device that is able to communicate the communication to the user, then the communication is communicated to the user using the other device, as in 812. If there is not another device that is able to communicate the communication to the user, then the communication is stored until it can be communicated to the user, as in 814.

It is also important to note that the operations in the preceding flow diagrams (i.e., FIGS. 4-8) illustrates only some of the possible scenarios and patterns that may be executed by, or within, electronic devices 100a-100h. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by electronic devices 100a-100h in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although electronic devices 100a-100h have been illustrated with reference to particular elements and operations that facilitate the communication process, these elements and operations may be replaced by any suitable architecture, protocols, and/or processes that achieve the intended functionality of electronic devices 100a-100h.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example S1 is a system for enabling migration of user related state across electronic devices. The system can include a plurality of electronic devices, where at least one electronic device includes, memory, one or more processors, a user proximity engine, and a state synchronization engine. The user proximity engine can be configured to cause the one or more processors to determine if a specific electronic device from the plurality of electronic devices is a most relevant device to a user. The state synchronization engine can be configured to cause the one or more processors to determine a state of the specific electronic device and communicate the state of the specific electronic device to a second electronic device if the specific electronic device is determined to be the most relevant device.

In Example S2, the subject matter of Example S1 can optionally include where the user proximity engine communicates with a second user proximity engine on the second electronic device to determine if the specific electronic device is the most relevant device to the user.

In Example S3, the subject matter of any one of the Examples S1-S2 can optionally include where each of the plurality of electronic devices includes the user proximity engine and the state synchronization engine.

In Example S4, the subject matter of any one of the Examples S1-S3 can optionally include where a second state synchronization engine located in the second electronic device includes a state matching engine and the state matching engine can configure a state of the second electronic device to match the state of the specific electronic device.

In Example S5, the subject matter of any one of the Examples S1-S4 can optionally include where the user proximity engine is further configured to cause the one or more processors to: determine that the specific electronic device is not the most relevant device to the user.

In Example S6, the subject matter of any one of the Examples S1-S5 can optionally include where each of the plurality of electronic devices communicate with each other to determine the most relevant device.

In Example S7, the subject matter of any one of the Examples S1-S6 can optionally include where the specific electronic device and the second electronic device communicate with each other through a local network.

In Example S8, the subject matter of any one of the Examples S1-S7 can optionally include where each of the plurality of electronic devices includes the user proximity engine and the local network includes the state synchronization engine.

In Example S9, the subject matter of any one of the Examples S1-S8 can optionally include where the specific electronic device and the second electronic device are different types of devices with different types of operating systems.

Example M1 is a method including determining that a first electronic device is a most relevant device to a user, determining a state of the first electronic device, determining that the first electronic device is no longer the most relevant device to the user, determining that a second electronic device is the most relevant device, and communicating the state of the first electronic device to the second electronic device.

In Example M2, the subject matter of Example M1 can optionally include matching the state of the second electronic device with the state of the first electronic device.

In Example M3, the subject matter of any one of the Examples M1-M2 can optionally include matching a portion of the state of the second electronic device with a portion of the state of the first electronic device and communicating a message to the user that only a portion of the state of the first electronic device was matched on the second electronic device.

In Example M4, the subject matter of any one of the Examples M1-M3 can optionally include determining that a third electronic device is the most relevant device and communicating a state of the second electronic device to the third electronic device.

In Example M5, the subject matter of any one of the Examples M1-M4 can optionally include where the first electronic device and the second electronic device communicate with each other through a local network.

Example A1, is an electronic device including one or more processors, a user proximity engine, and a state synchronization engine. The user proximity engine can be configured to cause the one or more processors to determine if the electronic device is a most relevant device to a user. The state synchronization engine can be configured to cause the one or more processors to determine a state of the electronic device and communicate the state of the electronic device to a second electronic device if the electronic device is determined to be the most relevant device.

In Example A2, the subject matter of Example A1 can optionally include where the user proximity engine communicates with a second user proximity engine on the second electronic device before determining if the electronic device is the most relevant device to the user.

In Example A3, the subject matter of any one of Examples A1-A2 can optionally include where the second electronic device includes a second state synchronization engine.

In Example A4, the subject matter of any one of Examples A1-A3 can optionally include where the second state synchronization engine includes a state matching engine and the state matching engine configures a state of the second electronic device to match the state of the electronic device.

In Example A5, the subject matter of any one of Examples A1-A4 can optionally include where the user proximity engine is further configured to cause the one or more processors to determine that the electronic device is not the most relevant device to the user and the state synchronization engine is further configured to cause the one or more processors to receive a state of another electronic device.

In Example A6, the subject matter of any one of Examples A1-A5 can optionally include where first electronic device and the second electronic device communicate with each other through a local network.

Example AA1 is an apparatus including means for determining that a first electronic device is a most relevant device to a user, means for determining a state of the first electronic device, means for determining that the first electronic device is no longer the most relevant device to the user, means for determining that a second electronic device is the most relevant device, and means for communicating the state of the first electronic device to the second electronic device.

In Example AA2, the subject matter of Example AA1 can optionally include means for matching the state of the second electronic device with the state of the first electronic device.

In Example AA3, the subject matter of any one of Examples AA1-AA2 can optionally include means for matching a portion of the state of the second electronic device with a portion of the state of the first electronic device and communicating a message to the user that only a portion of the state of the first electronic device was matched on the second electronic device.

In Example AA4, the subject matter of any one of Examples AA1-AA3 can optionally include means for determining that a third electronic device is the most relevant device and communicating a state of the second electronic device to the third electronic device.

In Example AA5, the subject matter of any one of Examples AA1-AA4 can optionally include where the first electronic device and the second electronic device communicate with each other through a local network.

Example X1 is a machine-readable storage medium including machine-readable instructions to implement a method or realize an apparatus as in any one of the Examples Al-A6, AA1-AA5, or M1-M5. Example Y1 is an apparatus comprising means for performing any of the Example methods M1-M5. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. A system for enabling migration of user related state across electronic devices, the system comprising:
a plurality of electronic devices, wherein at least one electronic device includes:
memory;
one or more processors;
a user proximity engine configured to cause the one or more processors to:
determine if a specific electronic device from the plurality of electronic devices is a most relevant device to a user; and
a state synchronization engine configured to cause the one or more processors to:
determine a state of the specific electronic device; and
communicate the state of the specific electronic device to a second electronic device if the specific electronic device is determined to be the most relevant device.

2. The system of claim 1, wherein the user proximity engine communicates with a second user proximity engine on the second electronic device to determine if the specific electronic device is the most relevant device to the user.

3. The system of claim 1, wherein each of the plurality of electronic devices includes the user proximity engine and the state synchronization engine.

4. The system of claim 1, wherein a second state synchronization engine located in the second electronic device includes a state matching engine and the state matching engine can configure a state of the second electronic device to match the state of the specific electronic device.

5. The system of claim 1, wherein the user proximity engine is further configured to cause the one or more processors to:
determine that the specific electronic device is not the most relevant device to the user.

6. The system of claim 1, wherein each of the plurality of electronic devices communicate with each other to determine the most relevant device.

7. The system of claim 1, wherein the specific electronic device and the second electronic device communicate with each other through a local network.

8. The system of claim 7, wherein each of the plurality of electronic devices includes the user proximity engine and the local network includes the state synchronization engine.

9. The system of claim 1, wherein the specific electronic device and the second electronic device are different types of devices with different types of operating systems.

10. A method comprising:
determining that a first electronic device is a most relevant device to a user;
determining a state of the first electronic device;
determining that the first electronic device is no longer the most relevant device to the user;
determining that a second electronic device is the most relevant device; and
communicating the state of the first electronic device to the second electronic device.

11. The method of claim 10, further comprising:
matching the state of the second electronic device with the state of the first electronic device.

12. The method of claim 10, further comprising:
matching a portion of the state of the second electronic device with a portion of the state of the first electronic device; and
communicating a message to the user that only a portion of the state of the first electronic device was matched on the second electronic device.

13. The method of claim 10, further comprising:
determining that a third electronic device is the most relevant device; and
communicating a state of the second electronic device to the third electronic device.

14. The method of claim 10, wherein the first electronic device and the second electronic device communicate with each other through a local network.

15. An electronic device comprising:
one or more processors;
a user proximity engine configured to cause the one or more processors to:
determine if the electronic device is a most relevant device to a user; and
a state synchronization engine configured to cause the one or more processors to:
determine a state of the electronic device; and
communicate the state of the electronic device to a second electronic device if the electronic device is determined to be the most relevant device.

16. The electronic device of claim 15, wherein the user proximity engine communicates with a second user proximity engine on the second electronic device before determining if the electronic device is the most relevant device to the user.

17. The electronic device of claim 15, wherein the second electronic device includes a second state synchronization engine.

18. The electronic device of claim 17, wherein the second state synchronization engine includes a state matching engine and the state matching engine configures a state of the second electronic device to match the state of the electronic device.

19. The electronic device of claim 15, wherein:
the user proximity engine is further configured to cause the one or more processors to:
determine that the electronic device is not the most relevant device to the user; and
the state synchronization engine is further configured to cause the one or more processors to:
receive a state of another electronic device.

20. The electronic device of claim 15, wherein first electronic device and the second electronic device communicate with each other through a local network.
